(19) United States
(12) Patent Application Publication
(10) Pub. No.: US 2010/0236846 A1
(43) Pub. Date: Sep. 23, 2010

(54) BATTERY PACK WITH DUAL MODE COOLING SCHEME

(76) Inventor: Dennis Kramer, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/408,186

(22) Filed: Mar. 20, 2009

(51) Int. Cl. B60K 6/20; F28D 15/00; H01M 10/50

(52) U.S. Cl. 180/65.21; 165/104.31; 429/120; 429/50

(57) ABSTRACT

A battery pack includes a plurality of battery modules mounted within a casing. A heat exchanger receives a fluid and a valve selectively connects one of two sources of fluid to the heat exchanger. One of the two sources is at a higher temperature for providing heating fluid to the heat exchanger, and a second of the sources is at a lower temperature to provide cooling fluid to the heat exchanger.

### BACKGROUND OF THE INVENTION

This application relates to a multi-cell battery pack for use in vehicle applications, wherein a liquid heat exchanger within the battery pack is alternatively provided with a source of heated fluid, or a source of cooling fluid, dependent on operational conditions.

More and more vehicles are being provided with electric drivelines. Electric motors may be utilized to drive axles, actuate brakes, etc. Large battery packs are required for such systems.

Heavy vehicles have been proposed which include battery packs assembled from hundreds of individual cells and grouped in modules. Of course, it is desirable to maintain and extend the battery life for such vehicles. With so many cells in a pack, the currents, voltages, and temperature of the several cells should be kept as constant with each other as is possible to evenly load the cells. If the cells are unevenly loaded, early failure could result.

One challenge with maintaining constant load on the cells is that the temperature of the cells will increase with use. It is known to provide cooling structure for the cells. As an example, fans have been proposed to circulate cooling air over the battery packs. The fans have typically been provided on an outer edge of the battery packs.

Another challenge with the use of the battery pack is operating in cold environments. If the battery pack is in an environment below 0° C., battery operation becomes more challenging. If the temperature drops even further, such as below −25° C., self-heating of the battery pack becomes minimal.

### SUMMARY OF THE INVENTION

A battery pack includes a plurality of battery modules mounted within a casing. A heat exchanger receives a fluid and a valve selectively connects one of two sources of fluid to the heat exchanger. One of the two sources is at a higher temperature for providing heating fluid to the heat exchanger, and a second of the sources is at a lower temperature to provide cooling fluid to the heat exchanger.

An electronic driveline for a vehicle, including the battery pack, and a method of cooling a battery pack are also disclosed and claimed.

These and other features of the present invention can be best understood from the following specification and drawings, the following of which is a brief description.

### BRIEF DESCRIPTION OF THE DRAWINGS

FIG. 1 shows a battery pack including a fan structure in a first condition.

FIG. 2 shows a subsequent condition.

### DETAILED DESCRIPTION OF THE PREFERRED EMBODIMENT

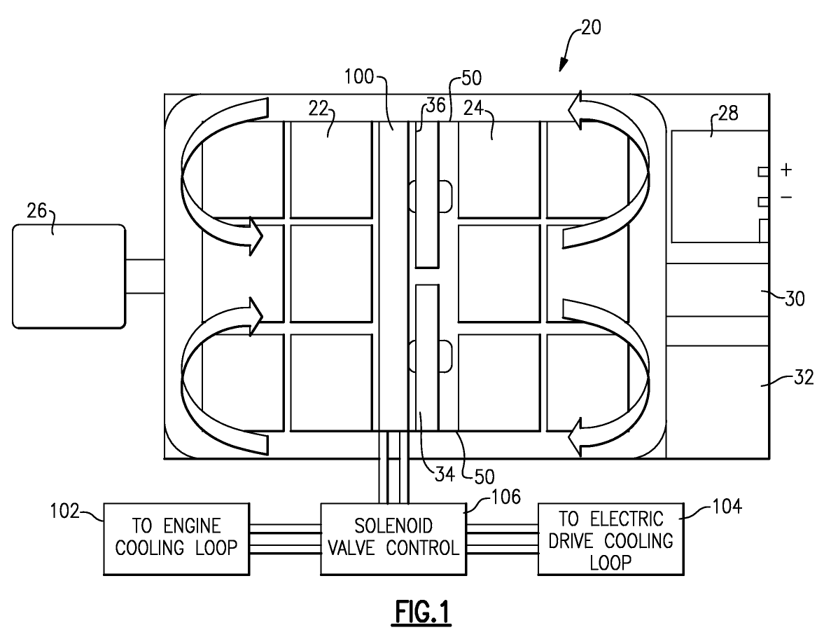

A battery pack 20 is illustrated in FIG. 1 having a plurality of multi-cell battery modules 22 and 24. As shown, the cell modules 22 and 24 are positioned on opposed sides of central fans 34 and 36.

The battery pack 20 drives electric motors 26, shown schematically. The electric motors 26 can be associated with heavy vehicle electric drive trains, and can include an axle drive, as an example. This portion of the invention may be as known in the art.

A battery management system 28 monitors voltage and provides feedback to a central vehicle control through an input/output connection.

A fan control 30 provides control signals to the fans 34 and 36. A disconnect 32 allows a manual electric disconnect, as is known.

A housing 50 surrounds the fans 34 and 36, and the modules 22 and 24.

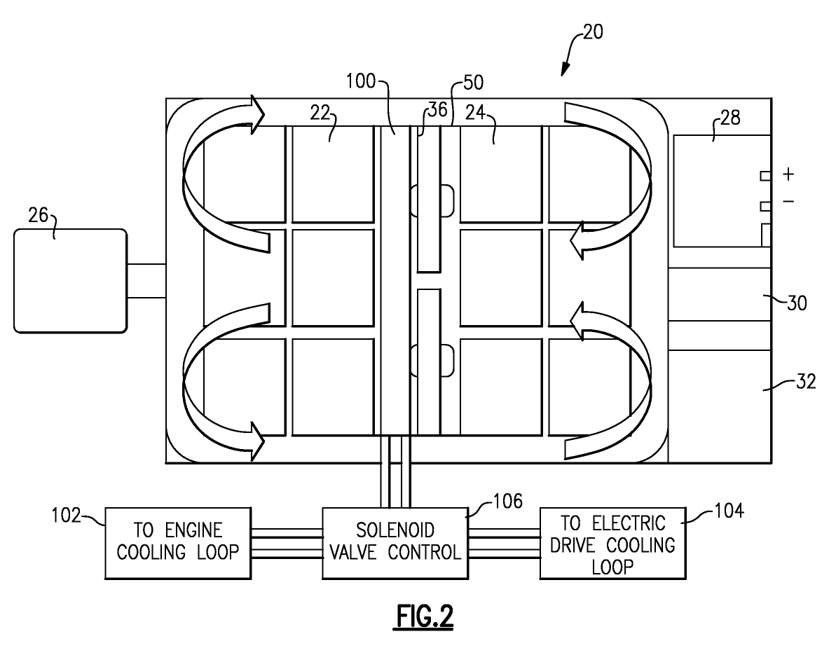

Due to the central location of the fans 34 and 36 between the modules 22 and 24, more even cooling will be provided than is the case in the prior art. While the fans 34 and 36 are shown at a central location with even numbers of modules 22 and 24 on both sides, other locations within the battery pack may come within the scope of this invention. In addition, the fan control 30 controls the fans 34 and 36 such that they flow in a first direction (left to right as shown in FIG. 1) for a period of time. After the passage of a period of time, the fan direction changes and the fans are reversed such that the airflow is from right to left, as shown in FIG. 2.

The airflow reversal time may be selected to be less than a cell thermal time constant of the multi-cell battery modules. The flow reversal cycles can be such that the direction changes at a time period less than one minute, and even less than every 30 seconds. In one disclosed embodiment, the reversal may occur every 10 seconds.

A challenge with the operation of a battery pack such as is illustrated in FIGS. 1 and 2 is maintaining desired temperatures. A liquid heat exchanger 100 is put in the intermediate location, and in proximity to the fans 34 and 36. The liquid heat exchanger cools or heats the air moved by the fans, and over the battery modules 22 and 24. As shown, a solenoid valve control 106 alternatively connects the engine cooling loop 102, or an electric drive cooling loop 104 to the heat exchanger 100. Other sources of liquid to be delivered into the heat exchanger 100 can be utilized.

Essentially, the engine cooling loop 102 will tend to be at higher temperatures, and the electric drive cooling loop 104 will tend to be at lower temperatures. The control 30, and/or the solenoid valve control 106, communicate with a vehicle controller, as an example, and determine whether heated or cooling liquid should be delivered into the heat exchanger 100.

Should cooling of the battery modules 22 and 24 be desired, then the solenoid valve control moves to connect the electric drive cooling loop 104 to the heat exchanger 100. Air moving over the heat exchanger 100 is cooled, and thus the modules 22 and 24 will be cooled.

On the other hand, if a vehicle receiving the battery pack 20 is in a cold environment, then the control moves to connect the engine cooling loop 102 to the heat exchanger 100. The air passing over the heat exchanger 100 will now be heated, as will be the battery modules 22 and 24.

While a worker of ordinary skill in this art can determine the temperatures at which to connect the two fluids, generally, cooling of the battery pack is desirable when internal temperatures are above 55° C., and heating is desirable when temperatures drop below 0° C. Generally, the engine cooling loop can become hot after continued operation, and could be at a temperature that would be undesirably high. As such, the control should ensure that the temperatures do not exceed desired limits. It may well be that under many conditions of operation, neither source of fluid is connected to the heat exchanger 100, and cooling is left to the fans 34 and 36.

The fans may use brushless, electronically commutated motors. A microprocessor control may be built into the fan drive.

The battery modules may be of the sort available from Energy Innovation Group (EiG), and as described at www.eigbattery.com. Of course, other battery modules would benefit from this invention.

In addition, co-pending and co-assigned patent applications entitled “Heavy Vehicle Battery Pack With Improved Cooling Scheme,” filed on even date herewith, and assigned Ser. No. ______, and “Battery Pack With Extended Operating Temperature Range,” filed on even date herewith, and assigned Ser. No. ______ should be studied as being somewhat related to the instant invention.

While the figures show a first layer of battery modules 22 and 24, and fans 34 and 36, it should be understood that there could be additional layers of each of these components extending into the plane of the paper. That is, there could be multiple layers within the actual total battery pack.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A battery pack comprising:
a plurality of battery modules mounted within a casing; and
a heat exchanger for receiving a fluid, and at least one fan, said heat exchanger and said at least one fan being at an intermediate position between groups of battery modules that make up said plurality of battery modules, and a valve to selectively connect one of two sources of fluid to said heat exchanger, one of said two sources being at a higher temperature for providing heating fluid to said heat exchanger, and a second of said sources being at a lower temperature to provide cooling fluid to said heat exchanger.

2. The battery pack as set forth in claim 1, wherein said at least one fan is mounted such that airflow to said fan and then downstream of said fan passes over some of said battery modules and said heat exchanger.

3. The battery pack as set forth in claim 2, wherein said at least one fan is a reversible fan such that said fan pulls air in a first direction for a first period of time, and then reverses flow and pulls air in an opposed direction for a second period of time.

4. The battery pack as set forth in claim 2, wherein said at least one fan and said at least one liquid heat exchanger are both mounted within said casing, and at a central location, with a plurality of battery modules both upstream of said fan, and downstream of said fan.

5. The battery pack as set forth in claim 1, wherein one of said sources of fluid is an engine cooling loop and provides said heating fluid, and the other of said sources of fluid is an engine drive cooling loop and provides said cooling fluid.

6. An electronic driveline for a vehicle comprising:
at least one electric motor, said at least one electric motor drawing power from a battery pack; and
a heat exchanger for receiving a fluid, and a valve to selectively connect one of two sources of fluid to said heat exchanger, one of said two sources being at a higher temperature for providing heating fluid to said heat exchanger, and a second of said sources being at a lower temperature to provide cooling fluid to said heat exchanger.

7. The electronic driveline as set forth in claim 6, wherein at least one fan is mounted such that airflow to said fan and then downstream of said fan passes over some of said battery modules and said heat exchanger.

8. The electronic driveline as set forth in claim 7, wherein said at least one fan is a reversible fan such that said fan pulls air in a first direction for a first period of time, and then reverses flow and pulls air in an opposed direction for a second period of time.

9. The electronic driveline as set forth in claim 7, wherein said at least one fan and said at least one liquid heat exchanger are both mounted within said casing, and at an intermediate location, with a plurality of battery modules both upstream of said fan, and downstream of said fan.

10. The electronic driveline as set forth in claim 6, wherein one of said sources of fluid is an engine cooling loop and provides said heating fluid, and the other of said sources of fluid is an engine drive cooling loop and provides said cooling fluid.

11. The electronic driveline as set forth in claim 6, wherein said at least electric motor is for driving a vehicle axle.

12. A method of maintaining a battery pack, said battery pack including a plurality of battery modules, and a liquid heat exchanger comprising the steps of:
determining whether said battery modules need heating or cooling;
communicating a first source of fluid to said heat exchanger that will tend to be at a higher temperature when it is determined that said battery modules need heating; and communicating a second source of fluid that will tend to be at a lower temperature to said heat exchanger when it is determined that said battery modules need cooling.

13. The method as set forth in claim 12, wherein a fan moves air over said heat exchanger and said plurality of battery modules.

14. The method as set forth in claim 13, wherein said fan is a reversible fan, and pulls air in a first direction for a first period of time over some of said battery modules upstream of said heat exchanger, and then over others of said battery modules downstream of said heat exchanger, and then said fan reverses flow and pulls air in an opposite direction for a second period of time.

15. The method as set forth in claim 14, wherein periods of time for fan reversal are selected to be less than one minute.
